(19) United States
(12) Patent Application Publication
(10) Pub. No.: US 2023/0187599 A1
(43) Pub. Date: Jun. 15, 2023

(54) METHOD FOR MANUFACTURING RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Masakazu UMEHARA, Toyota-shi (JP); Yuki HIRAHARA, Kurokawa-gun (JP); Naohiro ISHIZUKA, Sendai-shi (JP); Shunpei MORIYA, Toyokawa-shi (JP); Kou SAITO, Hamamatsu-shi (JP); Shingo MORI, Kurokawa-gun (JP); Seiji ISHIZU, Toyota-shi (JP); Taichi URAKAMI, Nissin-shi (JP); Yu ICHINO, Kariya-shi (JP); Naoya KISHIMOTO, Nagoya-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/078,020

(22) Filed: Dec. 8, 2022

(30) Foreign Application Priority Data
Dec. 13, 2021 (JP) 2021-201378

(51) Int. Cl. H01M 4/04; H01M 4/1391; H01M 4/62

(52) U.S. Cl. CPC H01M 4/0404; H01M 4/1391; H01M 4/622

(57) ABSTRACT

A method for manufacturing a rechargeable battery includes a simultaneous coating process for simultaneously coating an electrode substrate with one strip of a mixture paste and two strips of an insulation paste dispensed from a dispenser so that each widthwise end of the strip of the mixture paste is adjacent to a different strip of the insulation paste. The simultaneous coating process includes a gap adjustment process for changing a distance between the dispenser and the electrode substrate based on a coating width of the mixture paste, detected in the simultaneous coating process by an image inspection unit, so that the coating width of the mixture paste approaches a target value.

### BACKGROUND

### 1. Field

The following description relates to a method for manufacturing a rechargeable battery.

### 2. Description of Related Art

A non-aqueous rechargeable battery is used as a power source for a battery electric vehicle and a hybrid electric vehicle. One example of a non-aqueous rechargeable battery is a lithium-ion battery that includes electrode plates (positive and negative electrode plates). The electrode plate includes an elongated electrode substrate and a mixture layer formed by a mixture paste coating the electrode substrate. The electrode substrate includes a lateral edge defining an exposed portion where the mixture paste is not applied and the electrode substrate is exposed. The exposed portion is used as a collector connected to an external terminal. One of the positive electrode plate and the negative electrode plate includes an insulation layer that is formed by an insulation paste and located between the mixture layer and the exposed portion. The insulation layer prevents short-circuiting between the collector of the one of the electrode plates that includes the insulation layer and the end of the mixture layer on the other one of the electrode plates. Japanese Laid-Open Patent Publication No. 2016-119183 describes an example of a method for manufacturing an electrode body. The method coats an electrode substrate, which is transported in a predetermined direction, with an insulation paste after coating the electrode substrate with a mixture layer.

### SUMMARY

The width of the mixture paste applied to the electrode substrate may become unstable due to surface tension acting on a widthwise end of the mixture paste. Short-circuiting is effectively prevented when the widths of the mixture layer and the insulation layer are appropriate. It is thus important that the mixture paste be formed with the appropriate width.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One general aspect is a method for manufacturing a rechargeable battery. The method includes a simultaneous coating process for simultaneously coating an electrode substrate with one strip of a mixture paste and two strips of an insulation paste using a dispenser that dispenses the mixture paste and the insulation paste on the electrode substrate so that each widthwise end of the one strip of the mixture paste is adjacent to a different one of the two strips of the insulation paste. The simultaneous coating process includes a gap adjustment process for changing a distance between the dispenser and the electrode substrate based on a coating width of the mixture paste, detected in the simultaneous coating process by an image inspection unit, so that the coating width of the mixture paste approaches a target value.

In the method, the image inspection unit further detects a coating width of the insulation paste. The simultaneous coating process further includes a flowrate adjustment process for changing a flowrate of the insulation paste dispensed from the dispenser based on the coating width of the insulation paste detected by the image inspection unit after changing the distance between the dispenser and the electrode substrate so that the coating width of the insulation paste approaches a target value.

In the method, the flowrate adjustment process changes the flowrate of the insulation paste dispensed from the dispenser based on the coating width of the insulation paste detected by the image inspection unit after changing the distance between the dispenser and the electrode substrate from a first flowrate set before changing the distance between the dispenser and the electrode substrate to a second flowrate that is less than the first flowrate so that the coating width of the insulation paste approaches the target value.

Another general aspect is a method for manufacturing a rechargeable battery. The method includes a simultaneous coating process for simultaneously coating an electrode substrate with one strip of a mixture paste and two strips of an insulation paste using a dispenser that dispenses the mixture paste and the insulation paste on the electrode substrate so that each widthwise end of the one strip of the mixture paste is adjacent to a different one of the two strips of the insulation paste. The simultaneous coating process includes a flowrate adjustment process for changing a flowrate of the insulation paste dispensed from the dispenser from a first flowrate set when starting the simultaneous coating process to a second flowrate that is less than the first flowrate so that a coating width of the insulation paste approaches a target value.

The method further includes a sole coating process for coating the electrode substrate with only the mixture paste prior to the simultaneous coating process. The electrode substrate is continuously coated with the mixture paste during the sole coating process and the simultaneous coating process.

The method further includes a drying process for drying the mixture paste to form a mixture layer and drying the insulation paste to form the insulation layer after the simultaneous coating process. The mixture layer includes an active material, a conductive material, and a mixture binder. The insulation layer includes an insulative inorganic material and an insulation paste binder. A mass ratio of the insulation paste binder in the insulation layer is greater than a mass ratio of the mixture binder in the mixture layer.

In the method, the simultaneous coating process includes coating the electrode substrate so that the insulation paste moves into an area below a widthwise end of the mixture paste.

Other features and aspects will be apparent from the following detailed description, the drawings, and the claims.

### BRIEF DESCRIPTION OF THE DRAWINGS

FIG. 1 is a perspective view showing a cell of a lithium-ion battery.

FIG. 2 is a diagram showing an electrode body in a partially unrolled state.

FIG. 3 is a cross-sectional view of the electrode body in an unrolled state.

FIG. 4 is a schematic diagram of a coating system used to manufacture a positive electrode plate.

FIG. 5 is a schematic diagram of the coating system used to manufacture the positive electrode plate.

FIG. 6 is a flowchart illustrating the procedures for manufacturing the positive electrode plate.

FIG. 7 is a diagram showing a positive electrode mixture paste being dispensed from a dispenser in a sole coating process.

FIG. 8 is a plan view showing the positive electrode mixture paste applied to a positive electrode substrate in the sole coating process.

FIG. 9 is a diagram showing a state in which the distance between the dispenser and the positive electrode substrate is decreased in the sole coating process.

FIG. 10 is a plan view of the positive electrode substrate coated with the positive electrode mixture paste when the distance between the dispenser and the positive electrode substrate is decreased in the sole coating process.

FIG. 11 is a diagram showing the positive electrode mixture paste and an insulation paste dispensed from the dispenser in a simultaneous coating process.

FIG. 12 is a plan view showing the positive electrode substrate coated with the positive electrode mixture paste and the insulation paste in the simultaneous coating process.

FIG. 13 is a cross-sectional view showing the interface of the positive electrode mixture paste and the insulation paste coating the positive electrode substrate in the simultaneous coating process.

FIG. 14 is a graph showing the relationship of a gap, which is the distance between the dispenser and the positive electrode substrate, and a coating width of the positive electrode mixture paste.

FIG. 15 is a diagram showing a state in which the flowrate of the insulation paste is changed in the simultaneous coating process.

FIG. 16 is a graph showing the relationship of the flowrate of the insulation paste and the coating width of the insulation paste.

FIG. 17 is a time chart illustrating changes in the flowrate of the insulation paste.

FIG. 18 is a time chart illustrating changes in the coating width of the positive electrode mixture paste.

FIG. 19 is a time chart illustrating changes in the coating width of the insulation paste.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

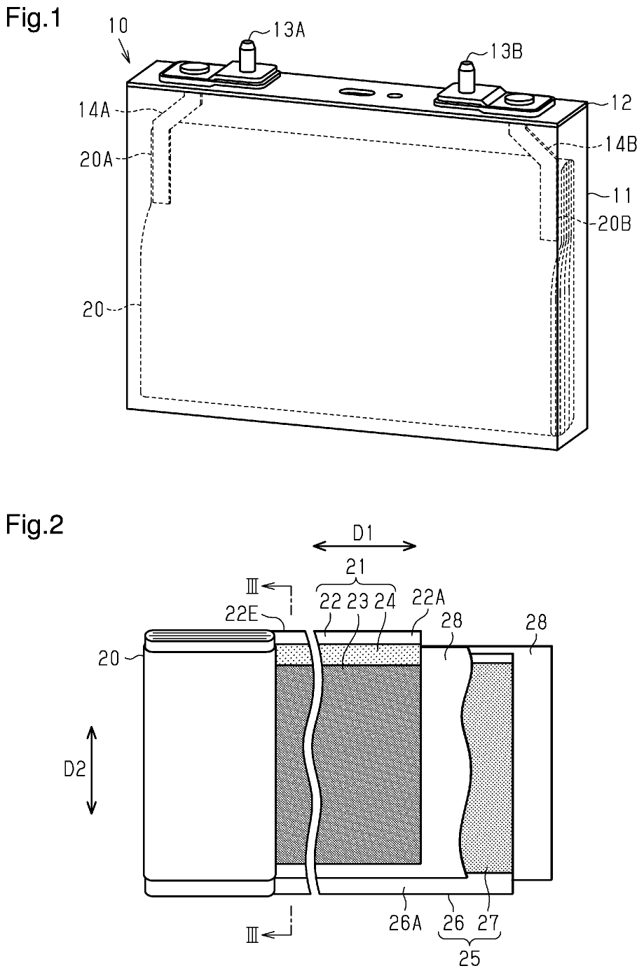

One embodiment of the present disclosure will now be described with reference to FIGS. 1 to 19.

Structure of Lithium-Ion Battery

FIG. 1 shows a lithium-ion battery 10, which is one example of a rechargeable battery. The lithium-ion battery 10 is a cell combined with other lithium-ion batteries and enclosed in a resin case or metal case to form a battery pack. The battery pack is used in a hybrid electric vehicle or a battery electric vehicle.

The lithium-ion battery 10 includes a battery case 11 and a lid 12. The battery case 11 is box-shaped and has an upper opening. The lid 12 closes the opening of the battery case 11. The battery case 11 and the lid 12 are formed from metal such as aluminum or an aluminum alloy. Attachment of the lid 12 to the battery case 11 forms a sealed battery jar of the lithium-ion battery 10.

The lid 12 includes two external terminals 13A and 13B. The external terminals 13A and 13B are used for charging and discharging. The battery case 11 accommodates an electrode body 20. The electrode body 20 includes a positive electrode end forming a positive electrode collector 20A that is electrically connected via a positive electrode collector member 14A to the positive electrode external terminal 13A. The electrode body 20 includes a negative electrode end forming a negative electrode collector 20B that is electrically connected via a negative electrode collector member 14B to the negative electrode external terminal 13B. The battery case 11 is filled with a non-aqueous electrolyte through an inlet (not shown). The external terminals 13A and 13B do not have to be shaped as illustrated in FIG. 1 and may have any shape.

Electrode Body

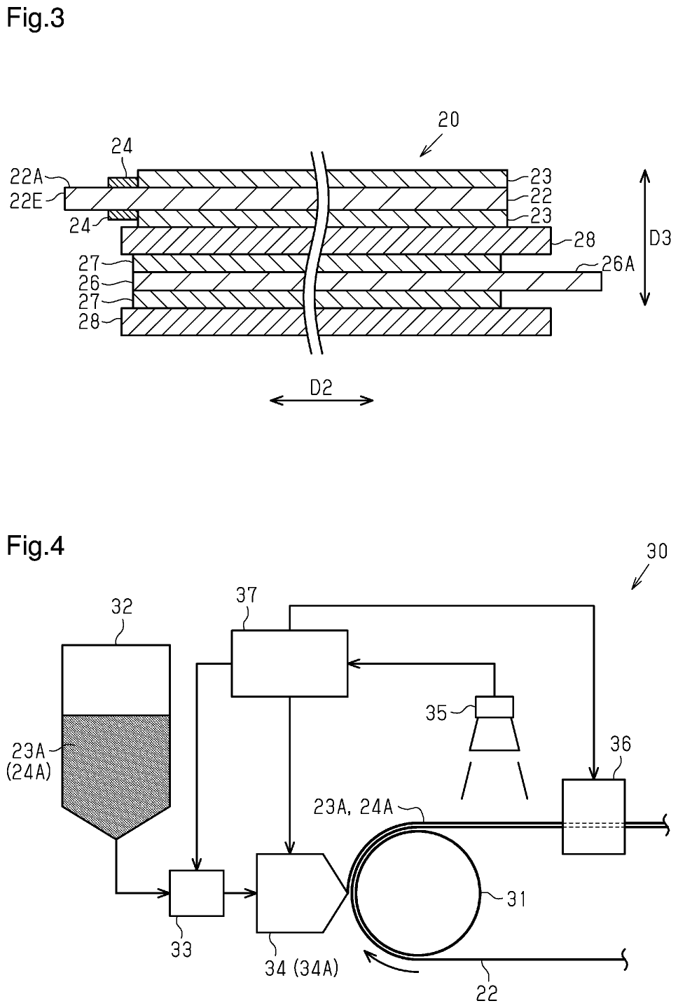

As shown in FIGS. 2 and 3, the electrode body 20 is a roll having a flattened form formed by rolling a stack of an elongated positive electrode plate 21, elongated separators 28, and an elongated negative electrode plate 25. The positive electrode plate 21 and the negative electrode plate 25 are examples of electrode plates forming the electrode body 20. Prior to rolling, the positive electrode plate 21, a separator 28, the negative electrode plate 25, and a separator 28 are stacked in this order in a thickness direction D3 (refer to FIG. 3). The positive electrode plate 21, the negative electrode plate 25, and each separator 28 are stacked so that the long sides are parallel to a longitudinal direction D1.

Positive Electrode Plate

The positive electrode plate 21 includes a positive electrode substrate 22, a positive electrode mixture layer 23, and an insulation layer 24. The positive electrode substrate 22 is an electrode substrate having the form of an elongated foil. The positive electrode mixture layer 23 is applied to each of the two opposite surfaces of the positive electrode substrate 22. The insulation layer 24 is applied adjacent to the positive electrode mixture layer 23 on each surface.

The positive electrode substrate 22 includes an edge 22E extending in the longitudinal direction D1. The edge 22E is defined by one of the ends of the positive electrode substrate 22 in the widthwise direction D2, that is, one of the short sides of the roll. The widthwise direction D2 is orthogonal to the longitudinal direction D1.

The portion of the positive electrode substrate 22 between the edge 22E and the insulation layer 24 defines an exposed portion 22A where the positive electrode substrate 22 is exposed and not coated with the positive electrode mixture layer 23 nor the insulation layer 24. The insulation layer 24 is applied to the positive electrode plate 21 at a location separated from the edge 22E of the positive electrode substrate 22. The positive electrode mixture layer 23 and the insulation layer 24 contact each other at an interfacial portion therebetween.

The positive electrode substrate 22 is a metal foil formed by aluminum or an alloy of which the main component is aluminum. The positive electrode substrate 22 has the functionality of a collector for a positive electrode. The exposed portion 22A of the positive electrode substrate 22 includes opposing surfaces pressed against one another when rolled and forming the positive electrode collector 20A.

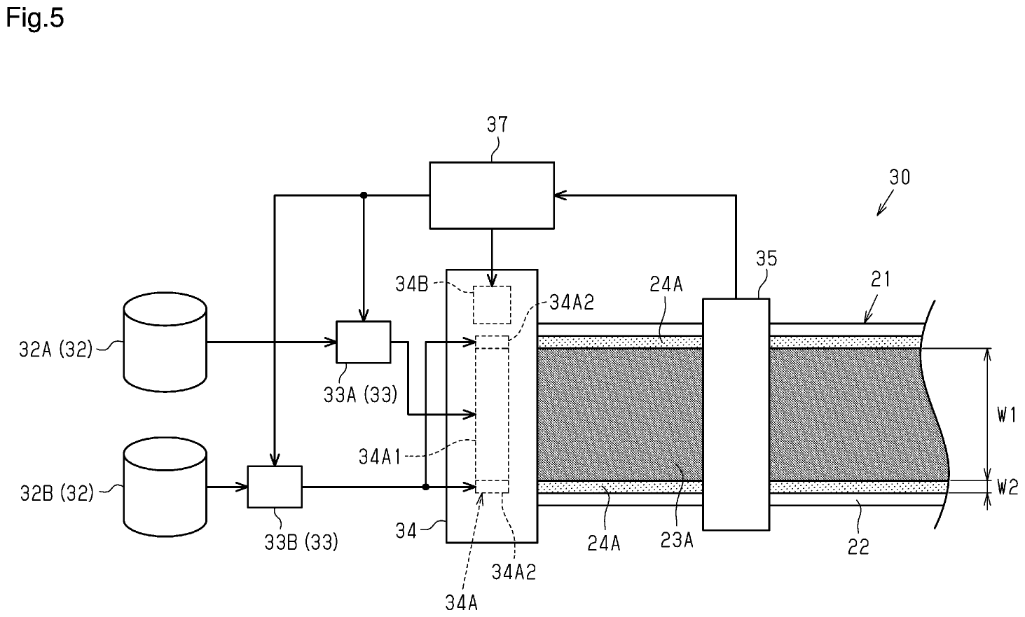

The positive electrode mixture layer 23 is formed by hardening the positive electrode mixture paste 23A, which is in a liquid form (refer to FIG. 5). The positive electrode mixture paste 23A is one example of a mixture paste including a positive electrode active material, a positive electrode conductive material, and a positive electrode binder as solid components and a positive electrode solvent as a liquid component. The positive electrode mixture paste 23A includes, for example, approximately 50 mass % to 70 mass % of solid components.

The positive electrode mixture layer 23 is hardened by drying the positive electrode mixture paste 23A and vaporizing the positive electrode solvent. Thus, among the components included in the positive electrode mixture paste 23A, the positive electrode mixture layer 23 includes the positive electrode active material, the positive electrode conductive material, and the positive electrode binder. The mass ratio of the positive electrode binder in the positive electrode mixture layer 23 is, for example, 0.3 mass % or greater and 5.0 mass % or less.

The positive electrode active material is a lithium-containing composite metal oxide that allows for the storage and release of lithium ions. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite oxide.

The lithium-containing composite oxide is, for example, lithium cobalt oxide (LiCoO₂), lithium nickel oxide (LiNiO₂), or lithium manganese oxide (LiMn₂O₄). The lithium-containing composite oxide is, for example, a three-element lithium-containing composite oxide that contains nickel, cobalt, and manganese, that is, lithium nickel manganese cobalt oxide (LiNiCoMnO₂). The lithium-containing composite oxide is, for example, lithium iron phosphate (LiFePO₄).

The positive electrode conductive material may be, for example, carbon black such as acetylene black or ketjen black, carbon nanotubes, carbon fiber such as carbon nanofiber, or graphite. The positive electrode binder is one example of a mixture binder. The positive electrode binder is, for example, polyvinylidene fluoride (PVDF), polyvinyl alcohol (PVA), or the like. The positive electrode solvent is one example of a mixture solvent. The positive electrode solvent is an N-methyl-2-pyrrolidone (NMP) solvent, which is one example of an organic solvent.

The insulation layer 24 is formed by hardening the insulation paste 24A, which is in a liquid form (refer to FIG. 5). The insulation paste 24A includes an insulative inorganic material and an insulation paste binder as a solid component and an insulation paste solvent as a liquid component. The insulation paste 24A includes, for example, approximately 15 mass % to 35 mass % of solid components. Thus, the insulation paste 24A is smaller in ratio of solid component than the positive electrode mixture paste 23A, lower in viscosity than the positive electrode mixture paste 23A, and higher in wettability than the positive electrode mixture paste 23A.

The insulation layer 24 is hardened by drying the insulation paste 24A and vaporizing the insulation paste solvent. Thus, among the components included in the insulation paste 24A, the insulation layer 24 includes the insulative inorganic material and the insulation paste binder. The mass ratio of the insulation paste binder in the insulation layer 24 is greater than the mass ratio of the positive electrode binder in the positive electrode mixture layer 23. Thus, the strength adhering the insulation layer 24 and the positive electrode substrate 22 is greater than the strength adhering the positive electrode mixture layer 23 and the positive electrode substrate 22. The mass ratio of the insulation paste binder in the insulation layer 24 is, for example, 3 mass % or greater and 40 mass % or less.

The insulative inorganic material is a powdered insulative inorganic material and at least one selected from the group consisting of boehmite powder, titania, and alumina. The insulation paste binder is a high polymer material soluble in NMP and at least one selected from the group consisting of PVDF, PVA, and acrylic. The insulation paste solvent is an NMP solution, which is one example of an organic solvent.

Negative Electrode Plate

As shown in FIGS. 2 and 3, the negative electrode plate 25 includes a negative electrode substrate 26, which is an electrode substrate having the form of an elongated foil, and a negative electrode mixture layer 27, which is applied to two opposite surfaces of the negative electrode substrate 26. The negative electrode plate 25 is formed by kneading the material of the negative electrode mixture layer 27 and then drying the kneaded material coating the negative electrode substrate 26.

The negative electrode substrate 26 has the functionality of a collector for a negative electrode. The negative electrode substrate 26 is a thin film of copper or an alloy of which the main component is copper. The end of the negative electrode substrate 26 in the widthwise direction D2 located opposite the exposed portion 22A of the positive electrode plate 21 includes an exposed portion 26A where the negative electrode substrate 26 is exposed and not coated with the negative electrode mixture layer 27. The exposed portion 26A includes opposing surfaces pressed against one another when rolled and forming the negative electrode collector 20B.

The negative electrode mixture layer 27 is formed by hardening a negative electrode mixture state, which is in a liquid form. The negative electrode mixture layer 27 includes a negative electrode active material that allows for the storage and release of lithium ions. The negative electrode active material is, for example, a carbon material or the like such as graphite, carbon that is difficult to graphitize, and carbon that is easy to graphitize. In addition to the negative electrode active material, the negative electrode active material includes a conductive agent, a binder, and the like.

Separator

The separator 28 prevents contact between the positive electrode plate 21 and the negative electrode plate 25 and holds non-aqueous electrolyte between the positive electrode plate 21 and the negative electrode plate 25. Immersion of the electrode body 20 in the non-aqueous electrolyte results in the non-aqueous electrolyte permeating the separator 28 from the ends toward the center.

The separator 28 is a nonwoven fabric of polypropylene or the like. The separator 28 may be, for example, a porous polymer film, such as a porous polyethylene film, a porous polyolefin film, or a porous polyvinyl chloride film, an ion conductive polymer electrolyte film, or the like.

Non-Aqueous Electrolyte

The non-aqueous electrolyte is a composition containing support salt in a non-aqueous solvent. The non-aqueous solvent is one or two or more selected from the group consisting of propylene carbonate, ethylene carbonate, diethyl carbonate, dimethyl carbonate, ethyl methyl carbonate, and the like. The support salt is a lithium compound of one or two or more selected from the group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt serving as an additive, is added to the non-aqueous electrolyte. For example, LiBOB is added to the non-aqueous electrolyte so that the concentration of LiBOB in the non-aqueous electrolyte is 0.001 mol/L or greater and 0.1 mol/L or less.

Manufacture of Positive Electrode Plate

The manufacture of the positive electrode plate 21 includes a coating process, a drying process, a pressing process, and a slitting process. In the coating process, the positive electrode substrate 22 is coated with the positive electrode mixture paste 23A and the insulation paste 24A. In the drying process, which follows the coating process, the positive electrode mixture paste 23A and the insulation paste 24A, which coat the positive electrode substrate 22, are dried. The drying process vaporizes the solvents from the positive electrode mixture paste 23A and the insulation paste 24A to form the positive electrode mixture layer 23 and the insulation layer 24 on the positive electrode substrate 22. In the pressing process, which follows the drying process, the positive electrode mixture layer 23, which is formed on the positive electrode substrate 22, is pressed and adjusted in thickness. In the slitting process, which follows the pressing process, the positive electrode substrate 22, which includes the positive electrode mixture layer 23 and the insulation layer 24, is slit into a given size. The positive electrode plate 21 is manufactured through the above procedures.

Coating System

The coating process for the present embodiment will now be described with reference to FIGS. 4 to 18. Referring to FIGS. 4 and 5, a coating system 30 is a line of devices that coat the positive electrode substrate 22 with the positive electrode mixture paste 23A and the insulation paste 24A and then dries the pastes.

As shown in FIG. 4, the coating system 30 includes a support roll 31, a paste hopper 32, a flowrate regulator 33, a coating device 34, an image inspection unit 35, a drying furnace 36, and a controller 37. The support roll 31 supports the positive electrode substrate 22 that is transported in a predetermined direction in the coating system 30.

The paste hopper 32 separately stores the positive electrode mixture paste 23A and the insulation paste 24A. The paste hopper 32 feeds the positive electrode mixture paste 23A and the insulation paste 24A via the flowrate regulator 33 to the coating device 34.

The flowrate regulator 33 controls the amount of the positive electrode mixture paste 23A and the insulation paste 24A fed from the paste hopper 32 to the coating device 34. The flowrate regulator 33 is, for example, a pressure valve or a mohno pump.

The coating device 34 includes a dispenser 34A and a drive unit 34B (refer to FIG. 5). The dispenser 34A dispenses the positive electrode mixture paste 23A and the insulation paste 24A onto the positive electrode substrate 22 supported by the support roll 31. The flowrate regulator 33 controls the flowrate of the positive electrode mixture paste 23A and the insulation paste 24A dispensed from the dispenser 34A. The drive unit 34B is a mechanism for moving the dispenser 34A and changing the distance between the dispenser 34A and the positive electrode substrate 22. The drive unit 34B is, for example, an actuator such as a motor or a slider.

The image inspection unit 35 inspects the coating width W1 of the positive electrode mixture paste 23A (refer to FIG. 5) and the coating width W2 of the insulation paste 24A (refer to FIG. 5) on the positive electrode substrate 22. The image inspection unit 35 sends the detected coating width W1 of the positive electrode mixture paste 23A and the detected coating width W2 of the insulation paste 24A to the controller 37. The drying furnace 36 exposes the positive electrode mixture paste 23A and the insulation paste 24A coating the positive electrode substrate 22 to a high-temperature drying atmosphere to perform drying.

The controller 37 includes a control unit, a memory, and a communication unit. The control unit controls the operation of the flowrate regulator 33 and the drive unit 34B. The control unit of the controller 37 may also be configured to control the operation of the image inspection unit 35 or the drying furnace 36. The memory stores programs, manufacturing conditions, and the like used to control the operation of the flowrate regulator 33 and the drive unit 34B. The communication unit is a mechanism allowing the controller 37 to establish communication with the flowrate regulator 33, the drive unit 34B, and devices controlled by the controller 37. The controller 37 drives the flowrate regulator 33 to change the flowrate of the positive electrode mixture paste 23A and the insulation paste 24A dispensed from the dispenser 34A. The controller 37 drives the drive unit 34B to change the distance between the dispenser 34A and the positive electrode substrate 22.

As shown in FIG. 5, the paste hopper 32 includes a first tank 32A and a second tank 32B. The first tank 32A stores the positive electrode mixture paste 23A. The second tank 32B stores the insulation paste 24A.

The flowrate regulator 33 includes a first flowrate regulation unit 33A and a second flowrate regulation unit 33B. The first flowrate regulation unit 33A is connected to the first tank 32A and the dispenser 34A. The first flowrate regulation unit 33A controls the flowrate of the positive electrode mixture paste 23A dispensed from the dispenser 34A. The second flowrate regulation unit 33B is connected to the second tank 32B and the dispenser 34A. The second flowrate regulation unit 33B controls the flowrate of the insulation paste 24A dispensed from the dispenser 34A.

The dispenser 34A of the coating device 34 includes a first dispensing unit 34A1 and two second dispensing units 34A2. The first dispensing unit 34A1 dispenses one strip of the positive electrode mixture paste 23A on the positive electrode substrate 22. The first dispensing unit 34A1 is connected via the first flowrate regulation unit 33A to the first tank 32A. The two second dispensing units 34A2 are located at opposite sides of the first dispensing unit 34A1. Each second dispensing unit 34A2 disperses one strip of the insulation paste 24A on the positive electrode substrate 22. The two second dispensing units 34A2 are each connected via the second flowrate regulation unit 33B to the second tank 32B.

Coating Process

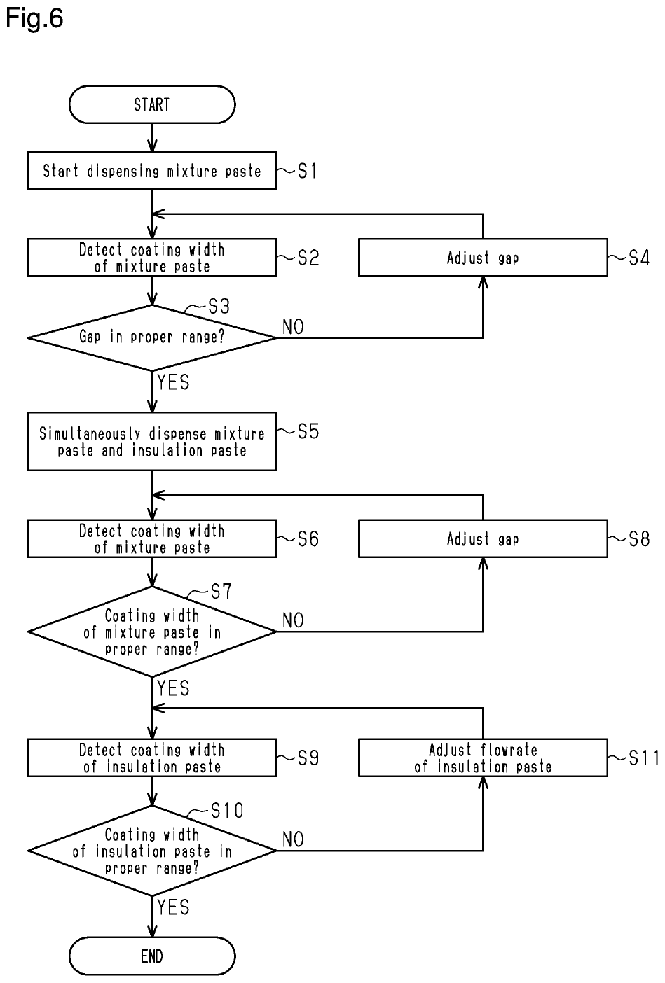

The coating process of the present embodiment will now be described with reference to FIGS. 6 to 17.

As shown in FIG. 6, the coating process of the present embodiment includes steps S1 to S11 that determine the manufacturing conditions of the distance between the dispenser 34A and the positive electrode substrate 22 and the flowrate of the insulation paste 24A. Steps S1 to S4 define a sole coating process in which the positive electrode mixture paste 23A is solely dispensed from the dispenser 34A. Steps S5 to S11 define a simultaneous coating process in which the positive electrode mixture paste 23A and the insulation paste 24A are simultaneously dispensed from the dispenser 34A.

Sole Coating Process

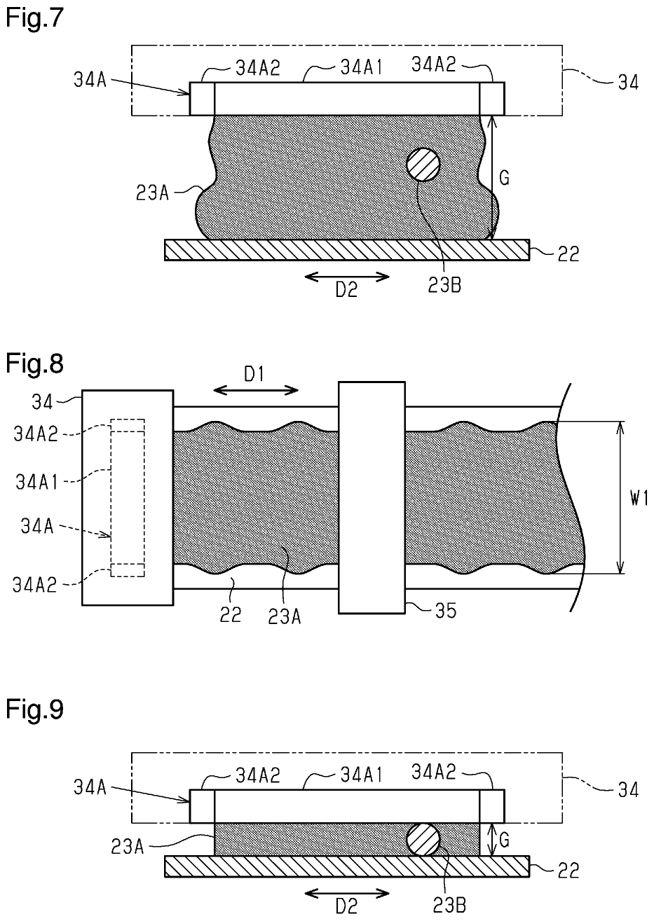

As shown in FIG. 7, in step S1, the first dispensing unit 34A1 of the dispenser 34A starts dispensing the positive electrode mixture paste 23A onto the positive electrode substrate 22. After starting the dispensing of the positive electrode mixture paste 23A in step S1, the first dispensing unit 34A1 continues to dispense the positive electrode mixture paste 23A at a constant flowrate until the entire coating process is completed. The dispensing of the positive electrode mixture paste 23A is started before the simultaneous coating process is started in step S5 so that the flowrate of the positive electrode mixture paste 23A is stable when the simultaneous coating process starts.

Distance Between Dispenser and Positive Electrode Substrate

The effect of the distance between the dispenser 34A and the positive electrode substrate 22 on the positive electrode mixture paste 23A coating the positive electrode substrate 22 when the dispenser 34A dispenses only the positive electrode mixture paste 23A will now be described with reference to FIGS. 7 to 10.

As shown in FIG. 7, the positive electrode mixture paste 23A includes aggregates 23B that are masses of collected grains formed from the solid components in the positive electrode mixture paste 23A. The ratio of the solid components in the positive electrode mixture paste 23A, the viscosity of the positive electrode mixture paste 23A, and the like affect the size of the aggregates 23B. For example, the aggregates 23B become larger as the ratio of the solid components in the positive electrode mixture paste 23A increases. As the ratio of the solid components in the positive electrode mixture paste 23A decreases, the aggregates 23B become smaller but the time required to dry the positive electrode mixture paste 23A becomes longer. The size of aggregates 23B can be expressed by average particle diameter such as median diameter D50. The average particle diameter of the aggregates 23B is, for example, approximately, ten to ninety micrometers.

In the present embodiment, the distance between the dispenser 34A and the positive electrode substrate 22, namely, gap G, is set to provide sufficient distance so that the aggregates 23B do not become stuck between the dispenser 34A and the positive electrode substrate 22 during the sole coating process and the simultaneous coating process.

Referring to FIG. 8, the present embodiment provides a sufficient gap G. This, however, results in non-uniform surface tension acting on the widthwise ends of the positive electrode mixture paste 23A coating the positive electrode substrate 22. Thus, the coating width W1 of the positive electrode mixture paste 23A becomes unstable.

As shown in FIG. 9, if the distance between the dispenser 34A and the positive electrode substrate 22, namely, gap G, were to be relatively small, surface tension acting on the positive electrode mixture paste 23A that reaches the positive electrode substrate 22 will limit variations and stabilize the coating width W1 of the positive electrode mixture paste 23A. However, when gap G is small, the difference in size between gap G and the aggregates 23B will be small. As a result, the aggregates 23B will easily become stuck between the dispenser 34A and the positive electrode substrate 22.

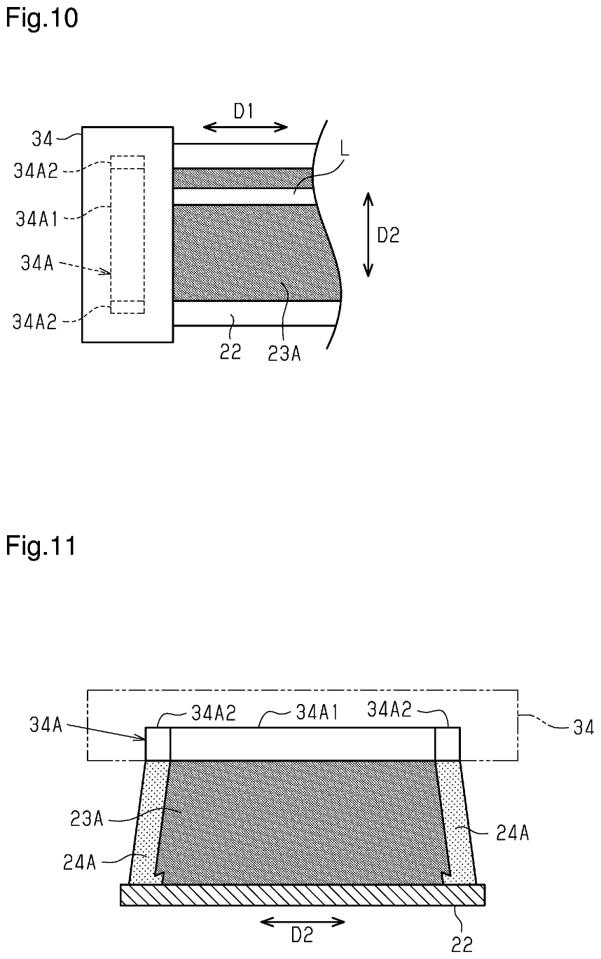

As shown in FIG. 10, when gap G is relatively small and an aggregate 23B becomes stuck between the dispenser 34A and the positive electrode substrate 22, interference of the aggregate 23B with the positive electrode mixture paste 23A coating the positive electrode substrate 22 may form a streak of a defective portion L. The defective portion L formed by interference of the aggregate 23B may hinder the application of the positive electrode mixture paste 23A where the positive electrode mixture paste 23A should be applied or partially change the thickness of the positive electrode mixture paste 23A. Thus, when coating the positive electrode substrate 22 with the positive electrode mixture paste 23A, gap G is set to be larger than the aggregates 23B in the positive electrode mixture paste 23A.

First Gap Adjustment Process

A first gap adjustment process performed in steps S2 to S4 during the sole coating process will now be described.

Referring to FIG. 8, in step S2, the image inspection unit 35 detects the coating width W1 of the positive electrode mixture paste 23A coating the positive electrode substrate 22. The image inspection unit 35 sends the detected coating width W1 of the positive electrode mixture paste 23A to the controller 37.

In step S3, based on the coating width W1 of the positive electrode mixture paste 23A detected by the image inspection unit 35 in step S2, the controller 37 determines whether gap G is within a proper range. The lower limit of gap Gin step S3 is set to be large enough so that aggregates 23B will not become stuck between the dispenser 34A and the positive electrode substrate 22, for example, larger than the average particle diameter of the aggregates 23B. The upper limit for the proper range of gap G is set so that the coating width W1 of the positive electrode mixture paste 23A does not become excessive.

Gap G and the coating width W1 of the positive electrode mixture paste 23A has a correlation in which the coating width W1 of the positive electrode mixture paste 23A increases as gap G becomes smaller, and the coating width W1 of the positive electrode mixture paste 23A decreases as gap G becomes larger. Based on the above correlation, the controller 37 determines that gap G is within the proper range when the minimum value of the coating width W1 of the positive electrode mixture paste 23A is greater than or equal to a lower limit value and the maximum value of the coating width W1 of the positive electrode mixture paste 23A is less than or equal to an upper limit value. Further, the controller 37 determines that gap G is outside the proper range when the maximum value of the coating width W1 of the positive electrode mixture paste 23A is greater than the upper limit value or the minimum value of the coating width W1 of the positive electrode mixture paste 23A is less than the lower limit value. When determined in step S3 that gap G is within the proper range, the coating process proceeds to step S5. When determined in step S3 that gap G is outside the proper range, the coating process proceeds to step S4.

Variations in the coating width W1 of the positive electrode mixture paste 23A decrease when gap G is small, and variations in the coating width W1 of the positive electrode mixture paste 23A increase when gap G is large. Thus, instead of using the minimum value and maximum value of the coating width W1 of the positive electrode mixture paste 23A as a criteria for determination, variations in the coating width W1 of the positive electrode mixture paste 23A (e.g., standard deviation) may be used to determine if gap G is within the proper range. For example, the controller 37 can determine that gap G is within the proper range when variations in the coating width W1 of the positive electrode mixture paste 23A are greater than or equal to a predetermined lower limit value and less than or equal to a predetermined upper limit value. Further, the controller 37 can determine that gap G is outside the proper range when variations in the coating width W1 of the positive electrode mixture paste 23A are greater than the predetermined upper limit value or less than the predetermined lower limit value. Such a criteria for determination also allows for determination of whether gap G is within the proper range.

In step S4, based on the coating width W1 of the positive electrode mixture paste 23A detected by the image inspection unit 35, the controller 37 moves the dispenser 34A to change gap G. For example, the dispenser 34A is moved toward the positive electrode substrate 22 to decrease gap G when the minimum value of the coating width W1 of the positive electrode mixture paste 23A detected by the image inspection unit 35 is less than the predetermined lower limit value. This increases the minimum value of the coating width W1 of the positive electrode mixture paste 23A. For example, the dispenser 34A is moved away from the positive electrode substrate 22 to increase gap G when the maximum value of the coating width W1 of the positive electrode mixture paste 23A detected by the image inspection unit 35 is greater than the predetermined upper limit value. This decreases the maximum value of the coating width W1 of the positive electrode mixture paste 23A. The controller 37 returns from step S4 to step S2 and repeats steps S2 to S4 until determining that gap G is within the proper range.

Simultaneous Coating Process

Referring to FIG. 11, in step S5, in a state in which the first dispensing unit 34A1 is dispensing the positive electrode mixture paste 23A, the two second dispensing units 34A2 also start dispensing the positive electrode substrate 22 onto the insulation paste 24A. Thus, in step S5, the first dispensing unit 34A1 dispenses one strip of the positive electrode mixture paste 23A and the two second dispensing units 34A2 dispense two strips of the insulation paste 24A onto the positive electrode substrate 22.

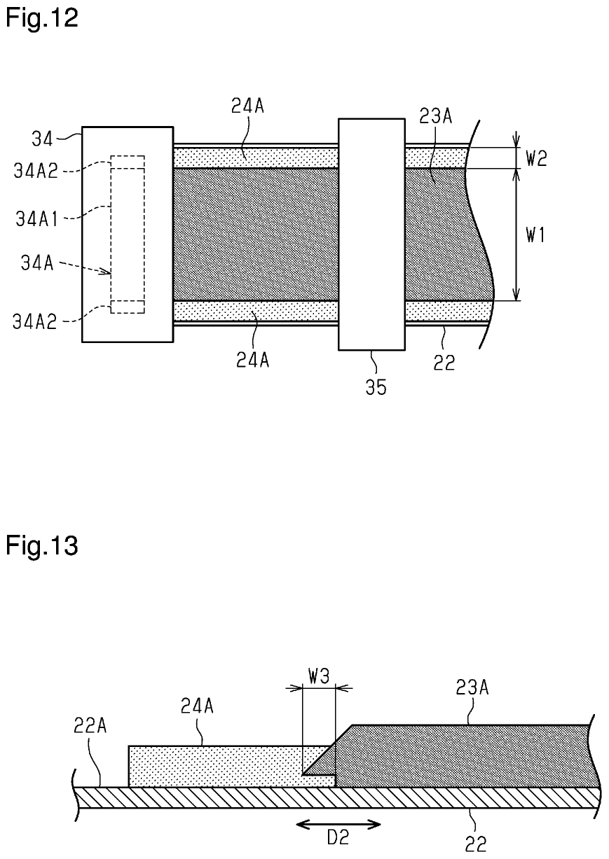

As shown in FIG. 12, in the simultaneous coating process, each widthwise end of the positive electrode mixture paste 23A is adjacent to a different one of the two strips of the insulation paste 24A. Thus, the coating width W1 of the positive electrode mixture paste 23A is set by the two strips of the insulation paste 24A. This allows the coating width W1 of the positive electrode mixture paste 23A to be stable even if the distance between the dispenser 34A and the positive electrode substrate 22 is increased to be larger than the aggregates 23B of the positive electrode mixture paste 23A.

In step S5, the second dispensing units 34A2 dispense the insulation paste 24A at a first flowrate V1 (refer to FIG. 17). The first flowrate V1 is, for example, a flowrate V that obtains a coating width greater than the target value of the coating width W2 of the insulation paste 24A. Accordingly, when the simultaneous coating process starts, the coating width W2 of the insulation paste 24A is greater than the target value. This allows the positive electrode mixture paste 23A and the insulation paste 24A to easily contact the positive electrode substrate 22 so that the coating width W1 of the positive electrode mixture paste 23A will be stable. The insulation paste 24A, which has a relatively high flowrate, sets the coating width W1 of the positive electrode mixture paste 23A. This shortens the coating distance required for the coating width W1 of the positive electrode mixture paste 23A to become stable. Thus, yield is improved.

The positive electrode mixture paste 23A is adjacent to the insulation paste 24A. Thus, the insulation layer 24, which is adhered with a greater strength to the positive electrode substrate 22 than the positive electrode mixture layer 23, is arranged adjacent to the widthwise ends of the positive electrode mixture layer 23. This limits separation of the positive electrode mixture layer 23 from the positive electrode substrate 22.

Interface of Positive Electrode Mixture Paste and Insulation Paste

With reference to FIG. 13, the insulation paste 24A has a lower viscosity than the positive electrode mixture paste 23A. Thus, the interface of the positive electrode mixture paste 23A and the insulation paste 24A is formed with the positive electrode mixture paste 23A pushing the insulation paste 24A. In the interface of the positive electrode mixture paste 23A and the insulation paste 24A, the insulation paste 24A is shaped covering the positive electrode mixture paste 23A. Further, the wettability of the insulation paste 24A on the positive electrode substrate 22 is higher than the wettability of the positive electrode mixture paste 23A on the positive electrode substrate 22. Thus, an end of the insulation paste 24A will move into an area below a corresponding end of the positive electrode mixture paste 23A. In the widthwise direction D2, an overlapping amount W3 of the insulation paste 24A and the positive electrode mixture paste 23A is, for example, 0.1 mm or greater and 1.0 mm or less.

Movement of the insulation paste 24A into the area below the positive electrode mixture paste 23A will result in the insulation layer 24, which is adhered with a great strength to the positive electrode substrate 22, being located between the widthwise ends of the positive electrode mixture layer 23 and the positive electrode substrate 22. Thus, separation of the positive electrode mixture layer 23 from the positive electrode substrate 22 will be further limited as compared with a structure in which the widthwise ends of the positive electrode mixture layer 23 are in contact with the positive electrode substrate 22.

Second Gap Adjustment Process

A second gap adjustment process performed in steps S6 to S8 during the simultaneous coating process will now be described.

Referring to FIG. 12, in step S6, the image inspection unit 35 detects the coating width W1 of the positive electrode mixture paste 23A dispensed in the simultaneous coating process. The image inspection unit 35 sends the detected coating width W1 of the positive electrode mixture paste 23A to the controller 37.

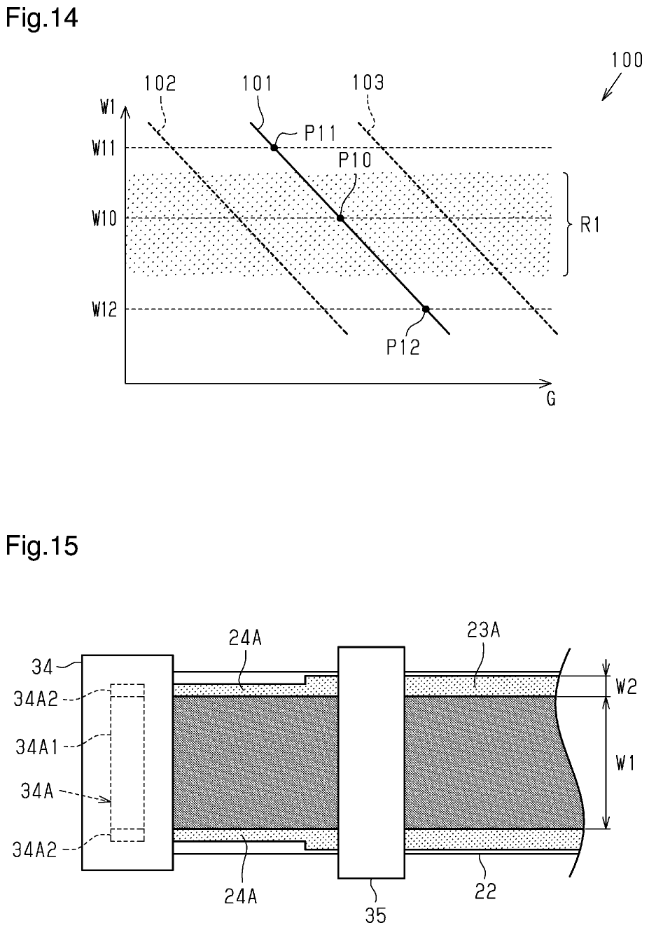

In step S7, based on the coating width W1 of the positive electrode mixture paste 23A detected in step S6 by the image inspection unit 35, the controller 37 determines whether the coating width W1 of the positive electrode mixture paste 23A is within a proper range R1 (refer to FIG. 14). The proper range R1 in step S7 is a target range set for the coating width W1 of the positive electrode mixture paste 23A. When determining in step S7 that the coating width W1 of the positive electrode mixture paste 23A is within the proper range R1, the controller 37 proceeds to step S9. When determining that the coating width W1 of the positive electrode mixture paste 23A is outside the proper range R1, the controller 37 proceeds to step S8.

In step S8, based on the coating width W1 of the positive electrode mixture paste 23A detected by the image inspection unit 35, the controller 37 changes gap G so that the coating width W1 of the positive electrode mixture paste 23A becomes within the proper range R1.

With reference to FIG. 14, the changing of gap Gin step S8 will now be described. In graph 100 of FIG. 14, line 101 indicates the relationship of gap G and the coating width W1 of the positive electrode mixture paste 23A. Line 102 indicates the relationship of gap G and the coating width W1 of the positive electrode mixture paste 23A when the viscosity of the positive electrode mixture paste 23A is higher than that of line 101. Line 103 indicates the relationship of gap G and the coating width W1 of the positive electrode mixture paste 23A when the viscosity of the positive electrode mixture paste 23A is lower than that of line 101. Lines 101 to 103 have the same inclination.

As shown in lines 101 to 103, the coating width W1 of the positive electrode mixture paste 23A decreases as gap G become larger, and the coating width W1 of the positive electrode mixture paste 23A increases as gap G becomes smaller. Further, the coating width W1 of the positive electrode mixture paste 23A decreases as the viscosity of the positive electrode mixture paste 23A becomes higher, and the coating width W1 of the positive electrode mixture paste 23A increases as viscosity of the positive electrode mixture paste 23A becomes lower.

In graph 100, point P10 in line 101 corresponds to where the coating width W1 of the positive electrode mixture paste 23A is width W10 that is the median value of the proper range R1. Point P11 in line 101 corresponds to where the coating width W1 of the positive electrode mixture paste 23A is width W11 that is greater than the proper range R1. Point P12 in line 101 corresponds to where the coating width W1 of the positive electrode mixture paste 23A is width W12 that is less than the proper range R1.

In step S8, when the image inspection unit 35 detects width W11 in step S6, the controller 37 moves the dispenser 34A away from the positive electrode substrate 22 to enlarge gap G. When the image inspection unit 35 detects width W12 in step S6, the controller 37 moves the dispenser 34A toward the positive electrode substrate 22 to reduce gap G. Thus, the coating width W1 of the positive electrode mixture paste 23A approaches width W10 so as to be included in the proper range R1. The controller 37 stores, for example, a relational expression representing line 101 in the memory. The controller 37 determines the movement amount of the dispenser 34A from the relational expression of line 101.

The second gap adjustment process is performed so that the coating width W1 of the positive electrode mixture paste 23A approaches the target value when the coating width W1 of the positive electrode mixture paste 23A is stable in the simultaneous coating process. Further, contact between the positive electrode mixture paste 23A and the insulation paste 24A allows the second gap adjustment process to adjust the coating width W1 of the positive electrode mixture paste 23A to the target value even when the coating width W1 of the positive electrode mixture paste 23A changes. The controller 37 returns from step S8 to step S6 and repeats steps S6 to S8 until determining that the coating width W1 of the positive electrode mixture paste 23A is within the proper range R1.

Flowrate Adjustment Process

A flowrate adjustment process performed in steps S9 to S11 during the simultaneous coating process will now be described. The flowrate adjustment process performs an adjustment so that the coating width W2 of the insulation paste 24A approaches the target value.

Referring to FIG. 15, in step S9, the image inspection unit 35 detects the coating width W2 of the insulation paste 24A after the second gap adjustment process. The image inspection unit 35 sends the detected coating width W2 of the insulation paste 24A to the controller 37.

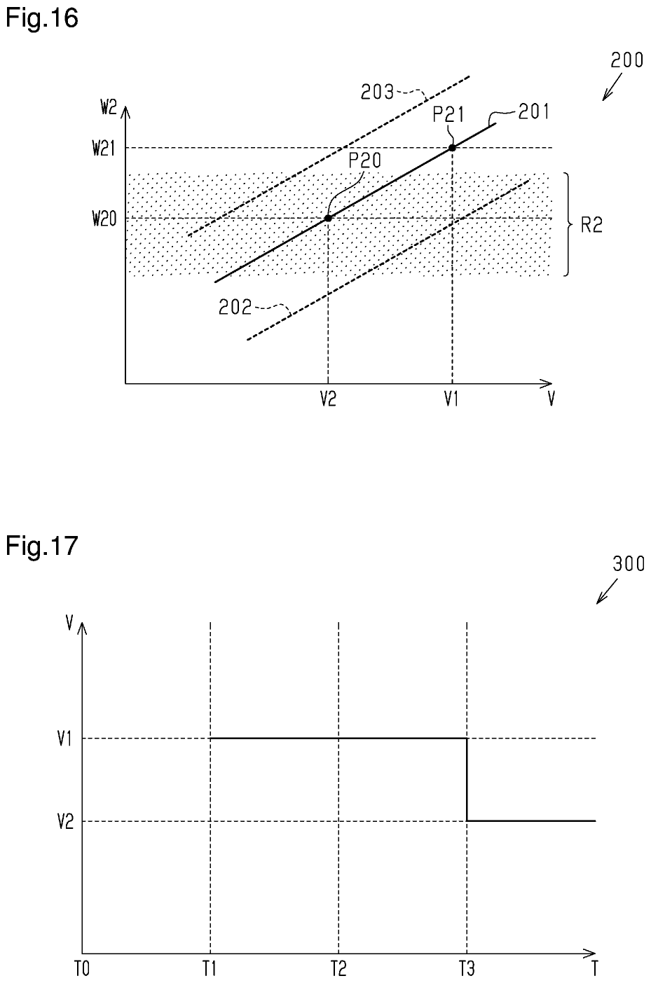

In step S10, based on the coating width W2 of the insulation paste 24A detected in step S9 by the image inspection unit 35, the controller 37 determines whether the coating width W2 of the insulation paste 24A is within a proper range R2 (refer to FIG. 16). The proper range R2 in step S10 is a target range set for the coating width W2 of the insulation paste 24A. When determined that the coating width W2 of the insulation paste 24A is within the proper range R2 in step S10, the determination of the manufacturing conditions for the coating process is completed. The coating process is then continuously performed. When determined that the coating width W2 of the insulation paste 24A is outside the proper range R2, the coating process proceeds to step S11.

In step S11, based on the coating width W2 of the insulation paste 24A detected by the image inspection unit 35, the controller 37 changes the flowrate V of the insulation paste 24A (refer to FIG. 16) so that the coating width W2 of the insulation paste 24A becomes included in the proper range R2.

With reference to FIG. 16, the changing of the flowrate V of the insulation paste 24A in step S11 will now be described. In graph 200 of FIG. 16, line 201 indicates the relationship of the flowrate V of the insulation paste 24A and the coating width W2 of the insulation paste 24A. Line 202 indicates the relationship of the flowrate V of the insulation paste 24A and the coating width W2 of the insulation paste 24A when gap G is larger than that of line 201. Line 203 indicates the relationship of the flowrate V of the insulation paste 24A and the coating width W2 of the insulation paste 24A when gap G is smaller than that of line 201. Lines 201 to 203 have the same inclination.

As shown in lines 201 to 203, the coating width W2 of the insulation paste 24A decreases as gap G becomes larger, and the coating width W2 of the insulation paste 24A increases as gap G becomes smaller. Further, the coating width W2 of the insulation paste 24A increases as the flowrate V of the insulation paste 24A becomes higher, and the coating width W2 of the insulation paste 24A decreases as the flowrate V of the insulation paste 24A becomes lower.

In graph 200, point P20 in line 201 corresponds to where the coating width W2 of the insulation paste 24A is width W20 that is the median value of the proper range R2. Point P21 in line 201 corresponds to where the coating width W2 of the insulation paste 24A is width W21 that is greater than the proper range R2. In the present embodiment, the first flowrate V1 that obtains a coating width greater than the target value of the coating width W2 is set when the simultaneous coating process is started in step S5. Thus, the coating width W2 of the insulation paste 24A detected in step S9 by the image inspection unit 35 is width W21 that is greater than the proper range R2.

In step S11, the controller 37 changes the flowrate V of the insulation paste 24A to a second flowrate V2 that is lower than the first flowrate V1 so that the coating width W2 of the insulation paste 24A changes from width W21 to width W20. The controller 37 stores, for example, a relational expression representing line 201 in the memory. Based on the relational expression of line 201, the controller 37 determines the changing amount of the flowrate V of the insulation paste 24A to change the first flowrate V1 to the second flowrate V2. This adjusts the coating width W2 of the insulation paste 24A to the target value.

FIG. 17 shows a graph 300 that is a time chart illustrating the flowrate V of the insulation paste 24A at each time T corresponding to step S1 to S11. At time T0, the coating process using the positive electrode mixture paste 23A is started (step S1). At time T1, the simultaneous coating process using the positive electrode mixture paste 23A and the insulation paste 24A is started (step S5). The insulation paste 24A is not dispensed from time T0 to time T1 during the sole coating process. The flowrate V of the insulation paste 24A at time T1 is the first flowrate V1. At time T2, the second gap adjustment process is performed to change gap G (step S8). At time T2, the flowrate V of the insulation paste 24A is maintained at the first flowrate V1. At time T3, the flowrate adjustment process is performed to change the flowrate V of the insulation paste 24A from the first flowrate V1 to the second flowrate V2 (step S11).

Coating Width of Positive Electrode Mixture Paste

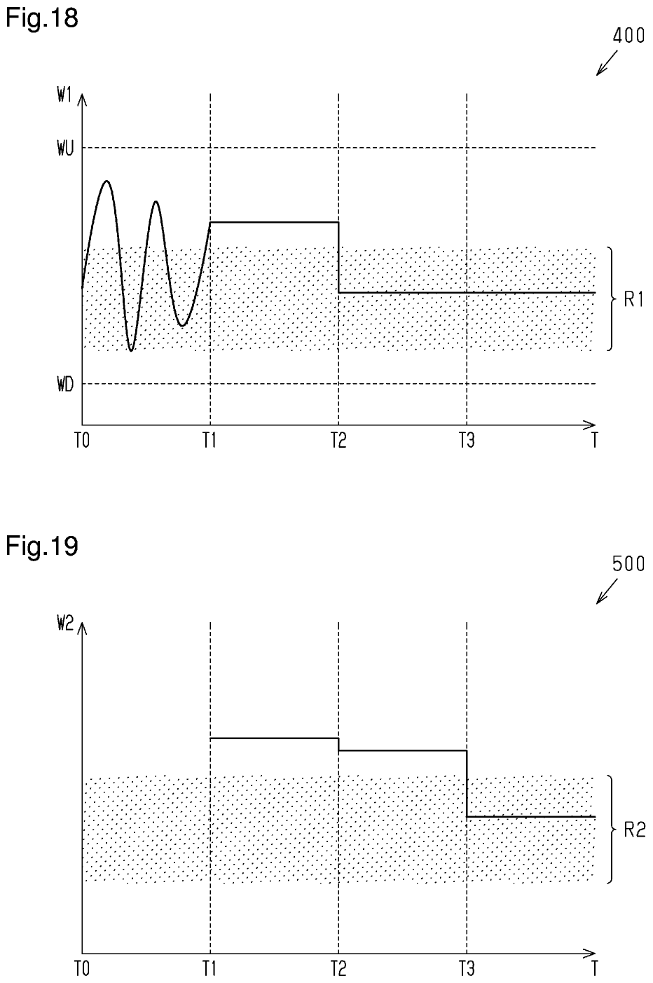

FIG. 18 shows a graph 400 that is a time chart illustrating the coating width W1 of the positive electrode mixture paste 23A at each time T corresponding to step S1 to S11. At time TO, the coating process using the positive electrode mixture paste 23A is started (step S1). During the sole coating process from time T0 to time T1, the coating width W1 of the positive electrode mixture paste 23A is unstable and varies within a range of the upper limit value WU and the lower limit value WD during the first gap adjustment process. At time T1, the simultaneous coating process using the positive electrode mixture paste 23A and the insulation paste 24A is started (step S5). This reduces variations in the coating width W1 of the positive electrode mixture paste 23A so that the coating width W1 becomes stable.

At time T2, the second gap adjustment process is performed to change gap G (step S8). This adjusts the coating width W1 of the positive electrode mixture paste 23A to a target value in the proper range R1. At time T3, the flowrate adjustment process is performed to change the flowrate V of the insulation paste 24A from the first flowrate V1 to the second flowrate V2 (step S11). From time T2, the coating width W1 of the positive electrode mixture paste 23A does not change greatly.

Coating Width of Insulation Paste

FIG. 19 shows a graph 500 that is a time chart illustrating the coating width W2 of the insulation paste 24A at each time T corresponding to step S1 to S11. At time T0, the coating process using the positive electrode mixture paste 23A is started (step S1). At time T1, the simultaneous coating process using the positive electrode mixture paste 23A and the insulation paste 24A is started (step S5). The insulation paste 24A is not dispensed from time T0 to time T1 during the sole coating process. Further, at time T1, the coating width W2 of the insulation paste 24A is greater than the proper range R2 because the insulation paste 24A is dispensed at the first flowrate V1.

At time T2, the second gap adjustment process is performed to change gap G (step S8). The second gap adjustment process changes gap G at time T2 to change the coating width W2 of the insulation paste 24A. At time T3, the flowrate adjustment process is performed to change the flowrate V of the insulation paste 24A from the first flowrate V1 to the second flowrate V2 (step S11). The flowrate adjustment process is performed after the second gap adjustment process to adjust the coating width W2 of the insulation paste 24A to the target value even if the second gap adjustment process changes the coating width W2 of the insulation paste 24A.

### Advantages of Embodiment

The advantages of the above embodiment will now be described.

(1) Two strips of the insulation paste 24A are arranged adjacent to the widthwise ends of the single strip of the positive electrode mixture paste 23A. Thus, the two strips of the insulation paste 24A set the coating width W1 of the positive electrode mixture paste 23A. This allows the coating width W1 of the positive electrode mixture paste 23A to be stable even if gap G is increased to be larger than the aggregates 23B in the positive electrode mixture paste 23A.

(2) The second gap adjustment process is performed to adjust the coating width W1 of the positive electrode mixture paste 23A to the target value when the coating width W1 of the positive electrode mixture paste 23A becomes stable as a result of the simultaneous dispensing of the positive electrode mixture paste 23A and the insulation paste 24A. Further, when, for example, interference of the insulation paste 24A results in the coating width W1 of the positive electrode mixture paste 23A being outside the proper range R1, gap G can be adjusted and changed so that the coating width W1 of the positive electrode mixture paste 23A approaches the target value.

(3) The flowrate adjustment process is performed after the second gap adjustment process. Thus, even if the second gap adjustment process changes the coating width W2 of the insulation paste 24A, the coating width W2 of the insulation paste 24A can be further adjusted to the target value.

(4) When the simultaneous coating process starts, the first flowrate V1, which is relatively high, is set as the flowrate V of the insulation paste 24A. This further ensures that the coating width W1 of the positive electrode mixture paste 23A will be stable. Further, the coating distance required until the coating width W1 of the positive electrode mixture paste 23A becomes stable is shortened, and the yield is improved. After the second gap adjustment process, the flowrate V of the insulation paste 24A is changed to the second flowrate V2 in order to adjust the coating width W2 of the insulation paste 24A to the target value.

(5) The sole coating process that dispenses only the positive electrode mixture paste 23A is performed before the simultaneous coating process. Thus, the flowrate of the positive electrode mixture paste 23A is stable when the simultaneous coating process starts.

(6) The first gap adjustment process is performed so that when starting the simultaneous coating process, gap G is optimally adjusted to cope with variations in viscosity of the positive electrode mixture paste 23A and manufacturing conditions between lots.

(7) The insulation layer 24, which is adhered with a greater strength to the positive electrode substrate 22 than the positive electrode mixture layer 23, is arranged adjacent to the widthwise ends of the positive electrode mixture layer 23. This limits separation of the positive electrode mixture layer 23 from the positive electrode substrate 22.

(8) The insulation layer 24 is arranged between the widthwise ends of the positive electrode mixture layer 23 and the positive electrode substrate 22. Thus, separation of the positive electrode mixture layer 23 from the positive electrode substrate 22 is further limited as compared with a structure in which the widthwise ends of the positive electrode mixture layer 23 are in contact with the positive electrode substrate 22.

### Modified Examples

The above embodiment may be modified as described below.

The insulation paste 24A does not have to move into the area below the positive electrode mixture paste 23A. More specifically, the widthwise ends of the positive electrode mixture layer 23 may be in contact with the positive electrode substrate 22. In this case, the arrangement of the insulation layer 24 adjacent to the widthwise ends of the positive electrode mixture layer 23 will still limit separation of the positive electrode mixture layer 23 from the positive electrode substrate 22.

The mass ratio of the insulation paste binder in the insulation layer 24 can be the same as or less than the mass ratio of the positive electrode binder in the positive electrode mixture layer 23. This will obtain advantages (1) to (6).

The first gap adjustment process performed in steps S2 to S4 during the sole coating process may be omitted. Even in this case, the positive electrode mixture paste 23A that is solely dispensed before the simultaneous coating process will allow the flowrate of the positive electrode mixture paste 23A to be stable when the simultaneous coating process starts.

The process of steps S1 to S4 performed before the simultaneous coating process, that is, the sole coating process that dispenses only the positive electrode mixture paste 23A, may be omitted. This will obtain advantages (1) to (4).

In the flowrate adjustment process, steps S9 and S10 may be omitted. In this case, in step S5, the simultaneous coating process is started with the flowrate V of the insulation paste 24A set to the first flowrate V1 so that the coating width W2 of the insulation paste 24A becomes greater than the target value. In step S11, the flowrate V of the insulation paste 24A is changed from the first flowrate V1 to the predetermined second flowrate V2 so that the coating width W2 of the insulation paste 24A approaches the target value. The second flowrate V2 for this case is a flowrate V that is set in advance so that the coating width W2 of the insulation paste 24A becomes equal to the target value. The difference between the first flowrate V1 and the second flowrate V2, that is the changing amount of the flowrate V of the insulation paste 24A in step S11, is fixed in this case. Further, the sole coating process, the second gap adjustment process, and steps S9 and S10 in the flowrate adjustment process may be omitted. This will obtain advantage (4).

In step S5, the first flowrate V1, which is the flowrate V of the insulation paste 24A when the simultaneous coating process starts, may be a flowrate V that obtains the target value for the coating width W2 of the insulation paste 24A. By performing the flowrate adjustment process, the coating width W2 of the insulation paste 24A will be adjusted to the target value even if the second gap adjustment process results in the coating width W2 of the insulation paste 24A differing from the target value. In this case, in step S11, the controller 37 changes the flowrate V of the insulation paste 24A from the first flowrate V1 so that the coating width W2 of the insulation paste 24A approaches the target value. Accordingly, the second flowrate V2 for this case is a flowrate V that differs from the first flowrate V1, a flowrate V that is greater than the first flowrate V1, or a flowrate that is less than the first flowrate V1.

If the first flowrate V1 for the flowrate V of the insulation paste 24A when starting the simultaneous coating process is the flowrate V that obtains the target value for the coating width W2 of the insulation paste 24A, the flowrate adjustment process of steps S9 to S11 may be omitted. Thus, the flowrate V of the insulation paste 24A may be fixed. This will obtain advantages (1) to (2).

In the above embodiment, the positive electrode plate 21 includes the insulation layer 24. Instead, the negative electrode plate 25 may include an insulation layer at the interface of the exposed portion 26A and the negative electrode mixture layer 27. In this case, the negative electrode plate 25 may be manufactured through a process similar to that of the positive electrode plate 21.

The rechargeable battery is the lithium-ion battery 10 in the above embodiment. Nevertheless, the manufacturing method of the above embodiment may be applied to any rechargeable battery that uses an electrode plate including an electrode substrate, a mixture layer, an insulation layer, and an exposed portion. Thus, the rechargeable battery is not limited to a non-aqueous rechargeable battery, such as the lithium-ion battery 10, and may be, for example, a nickel metal hydride battery.

In the above embodiment, the electrode body 20 is a roll formed by rolling a stack of the positive electrode plate 21 and the negative electrode plate 25 with the separator 28 arranged in between. Instead, the electrode body 20 may be, for example, positive electrode plates 21 and negative electrode plate 25 stacked alternately with a separator 28 arranged in between.

The lithium-ion battery 10 may be used in an automatic transporting vehicle, a special hauling vehicle, a battery electric vehicle, a hybrid electric vehicle, a computer, an electronic device, or any other systems. For example, the lithium-ion battery 10 may be used in a marine vessel, an aircraft, or any other type of movable body. The lithium-ion battery 10 may also be used in a system that supplies electric power from a power plant via a substation to buildings and households.

### EXAMPLES

Examples 1 and 2 and Comparative examples 1 and 2 of the positive electrode plate 21 will now be described. These examples are not intended to limit the above embodiment.

### Example 1

In example 1, the positive electrode substrate 22 was coated with one strip of the positive electrode mixture paste 23A and two strips of the insulation paste 24A. The ratio of solid components in the positive electrode mixture paste 23A was 65 mass %. The average particle diameter of the aggregates 23B in the positive electrode mixture paste 23A was 50 μm in median diameter D50. The dimension of gap G was 75 μm. Further, gap G was not changed and thus fixed in the first gap adjustment process of steps S2 to S4 and the second adjustment process of steps S6 to S8.

The first flowrate V1 of the insulation paste 24A when starting the simultaneous coating step in step S5 was set to a flowrate V that obtains a larger coating width than the target value for the coating width W2 of the insulation paste 24A. In the flowrate adjustment process of steps S9 to S11, the flowrate V of the insulation paste 24A was changed from the first flowrate V1 to the second flowrate V2 that obtains the target value for the coating width W2 of the insulation paste 24A.

### Example 2

In example 2, the first flowrate V1 of the insulation paste 24A when starting the simultaneous coating step in step S5 was set to a flowrate V that obtains the target value for the coating width W2 of the insulation paste 24A. Further, in example 2, the flowrate adjustment process of steps S9 to S11 was not performed, and the flowrate V of the insulation paste 24A was fixed at the first flowrate V1. Although example 2 had differences from example 1 in the points described above, the positive electrode substrate 22 was coated with one strip of the positive electrode mixture paste 23A and two strips of the insulation paste 24A in the same manner.

### Comparative Example

In comparative example 1, the positive electrode substrate 22 was coated with only one strip of the positive electrode mixture paste 23A. The ratio of solid components in the positive electrode mixture paste 23A was 55 mass %. The average particle diameter of the aggregates 23B in the positive electrode mixture paste 23A was 50 μm in median diameter D50. The dimension of gap G was fixed at 75 μm.

### Comparative Example 2

In comparative example 2, the positive electrode substrate 22 was coated with only one strip of the positive electrode mixture paste 23A. The ratio of solid components in the positive electrode mixture paste 23A was 65 mass %. The average particle diameter of the aggregates 23B in the positive electrode mixture paste 23A was 50 μm in median diameter D50. The dimension of gap G was fixed at 45

Evaluation 1

Evaluation 1 relates to the time required for drying the positive electrode mixture paste 23A coating the positive electrode substrate 22. In evaluation 1, good indicates that the time for drying the positive electrode mixture paste 23A was short, and poor indicates that the time required for drying the positive electrode mixture paste 23A was long.

Evaluation 2

Evaluation 2 relates to the presence of a streak-like defective portion L, caused by interference with an aggregate 23B, in the positive electrode mixture paste 23A coating the positive electrode substrate 22. In evaluation 2, good indicates that a streak-like defective portion L was not found, and poor indicates that a streak-like defective portion L was found.

Evaluation 3

Evaluation 3 relates to the stability of the coating width W1 of the positive electrode mixture paste 23A coating the positive electrode substrate 22. In evaluation 3, poor indicates that the coating width W1 of the positive electrode mixture paste 23A was unstable, and good indicates that the coating width W1 of the positive electrode mixture paste 23A was stable. Further, in evaluation 3, when the coating width W1 of the positive electrode mixture paste 23A was stable, exc (excellent) indicates that the distance required for the coating width W1 of the positive electrode mixture paste 23A to become stable was particularly short.

TABLE 1

| | | | | | | Stable |
|---|---|---|---|---|---|---|
| | Insulation | Solid | | Dry- | | Coating |
| Sample 1 | Layer | Component | Gap | ness | Defect | Width |
| Example 1 | Available | 65% | 75 μm | Good | Good | Exc |
| Example 2 | Available | 65% | 75 μm | Good | Good | Good |
| Com. | N/A | 55% | 75 μm | Poor | Good | Poor |
| Ex. 1 | | | | | | |
| Com. | N/A | 65% | 45 μm | Good | Poor | Good |
| Ex. 2 | | | | | | |

As shown in table 1, in examples 1 and 2 and comparative example 2, the time required to dry the positive electrode mixture paste 23A was relatively short. In comparative example 1, the ratio of solid components in the positive electrode mixture paste 23A was relatively small. Thus, the time required to dry the positive electrode mixture paste 23A was longer than examples 1 and 2 and comparative example 2.

In examples 1 and 2 and comparative example 1, a streak-like defective portion L was not found in the positive electrode mixture paste 23A coating the positive electrode substrate 22. On the other hand, in comparative example 2, a streak-like defective portion L was found in the positive electrode mixture paste 23A coating the positive electrode substrate 22. In comparative example 2, gap G was smaller than the average particle diameter of the aggregates 23B. For this reason, it is understood that aggregates 23B became stuck between the dispenser 34A and the positive electrode substrate 22.

In examples 1 and 2 and comparative example 2, the coating width W1 of the positive electrode mixture paste 23A was stable. In example 1, the distance was particularly short during which the coating width W1 of the positive electrode mixture paste 23A was unstable. In example 1, the first flowrate V1 of the insulation paste 24A was relatively high. For this reason, it is understood that the coating width W1 of the positive electrode mixture paste 23A became stable within a short distance. In comparative example 2, gap G was small. Thus, the coating width W1 of the positive electrode mixture paste 23A became stable as soon as the flowrate of the positive electrode mixture paste 23A became stable. In comparative example 1, gap G was relatively large, and the insulation paste 24A was not applied. Thus, the coating width W1 of the positive electrode mixture paste 23A was unstable.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a rechargeable battery, the method comprising:
a simultaneous coating process for simultaneously coating an electrode substrate with one strip of a mixture paste and two strips of an insulation paste using a dispenser that dispenses the mixture paste and the insulation paste on the electrode substrate so that each widthwise end of the one strip of the mixture paste is adjacent to a different one of the two strips of the insulation paste;
wherein the simultaneous coating process includes a gap adjustment process for changing a distance between the dispenser and the electrode substrate based on a coating width of the mixture paste, detected in the simultaneous coating process by an image inspection unit, so that the coating width of the mixture paste approaches a target value.

2. The method according to claim 1, wherein:
the image inspection unit further detects a coating width of the insulation paste; and
the simultaneous coating process further includes a flowrate adjustment process for changing a flowrate of the insulation paste dispensed from the dispenser based on the coating width of the insulation paste detected by the image inspection unit after changing the distance between the dispenser and the electrode substrate so that the coating width of the insulation paste approaches a target value.

3. The method according to claim 2, wherein the flowrate adjustment process changes the flowrate of the insulation paste dispensed from the dispenser based on the coating width of the insulation paste detected by the image inspection unit after changing the distance between the dispenser and the electrode substrate from a first flowrate set before changing the distance between the dispenser and the electrode substrate to a second flowrate that is less than the first flowrate so that the coating width of the insulation paste approaches the target value.

4. The method according to claim 1, further comprising:
a sole coating process for coating the electrode substrate with only the mixture paste prior to the simultaneous coating process,
wherein the electrode substrate is continuously coated with the mixture paste during the sole coating process and the simultaneous coating process.

5. The method according to claim 1, further comprising:
a drying process for drying the mixture paste to form a mixture layer and drying the insulation paste to form the insulation layer after the simultaneous coating process, wherein:
the mixture layer includes an active material, a conductive material, and a mixture binder;
the insulation layer includes an insulative inorganic material and an insulation paste binder; and
a mass ratio of the insulation paste binder in the insulation layer is greater than a mass ratio of the mixture binder in the mixture layer.

6. The method according to claim 5, wherein the simultaneous coating process includes coating the electrode substrate so that the insulation paste moves into an area below a widthwise end of the mixture paste.

7. A method for manufacturing a rechargeable battery, the method comprising:
a simultaneous coating process for simultaneously coating an electrode substrate with one strip of a mixture paste and two strips of an insulation paste using a dispenser that dispenses the mixture paste and the insulation paste on the electrode substrate so that each widthwise end of the one strip of the mixture paste is adjacent to a different one of the two strips of the insulation paste;
wherein the simultaneous coating process includes a flowrate adjustment process for changing a flowrate of the insulation paste dispensed from the dispenser from a first flowrate set when starting the simultaneous coating process to a second flowrate that is less than the first flowrate so that a coating width of the insulation paste approaches a target value.

8. The method according to claim 7, further comprising:
a sole coating process for coating the electrode substrate with only the mixture paste prior to the simultaneous coating process,
wherein the electrode substrate is continuously coated with the mixture paste during the sole coating process and the simultaneous coating process.

9. The method according to claim 7, further comprising:
a drying process for drying the mixture paste to form a mixture layer and drying the insulation paste to form the insulation layer after the simultaneous coating process, wherein:
the mixture layer includes an active material, a conductive material, and a mixture binder;
the insulation layer includes an insulative inorganic material and an insulation paste binder; and
a mass ratio of the insulation paste binder in the insulation layer is greater than a mass ratio of the mixture binder in the mixture layer.

10. The method according to claim 9, wherein the simultaneous coating process includes coating the electrode substrate so that the insulation paste moves into an area below a widthwise end of the mixture paste.
